(19) United States
(12) Patent Application Publication
(10) Pub. No.: US 2003/0055144 A1
(43) Pub. Date: Mar. 20, 2003

(54) Heat resistant liquid crystalline polymer parts

(76) Inventors: Marion Glen Waggoner, Landenberg, PA (US); Steve Gust Cottis, West Windsor, NJ (US); Michael Robert Samuels, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/245,663

(22) Filed: Sep. 17, 2002

Related U.S. Application Data
(63) Continuation of application No. 09/608,369, filed on Jun. 30, 2000.
(60) Provisional application No. 60/143,369, filed on Jul. 12, 1999.

(51) Int. Cl. C08L 1/00

(52) U.S. Cl. 524/423

(57) ABSTRACT

Parts, especially ovenware parts, made from certain liquid crystalline polymers and optionally fillers, reinforcing agents and/or pigments, which have low blistering and/or warpage may be made by addition of small amounts of alkali metal ion to the liquid crystalline polymer and/or certain melt mixing conditions when preparing the composition.

This application claims the benefit of U.S. Provisional Application No. 60/143,369, filed Jul. 12, 1999.

### FIELD OF THE INVENTION

This invention relates to molded parts of certain liquid crystalline polymers (LCPs) containing small amounts of alkali metal cations, which are particularly useful where high temperature resistance is needed, especially where the temperatures cycles up and down.

### TECHNICAL BACKGROUND

It is well known that liquid crystalline polymers (LCPs) are useful in some of their applications because they can be used at high temperatures. However, it has been found that when heated to high temperatures LCPs sometimes blister, that is form bubbles within the polymer, which appear as mounds on the surface of the polymer part. These LCPs may also warp with temperature changes or temperature cycling, especially if they are relatively thin parts with a large surface area. It has been discovered that when these LCPs contain small amounts of an alkali metal the tendency to blister and/or warp is reduced. This is useful in parts which are heated to high temperatures, and particularly for parts that are cycled between low temperature and high temperature in use.

U.S. Pat. No. 5,397,502 describes compositions of certain LCPs containing selected metals, including alkali metals. Their use as ovenware is not mentioned.

U.S. Pat. No. 4,742,149 describes certain LCPs containing metal ions, including alkali metal ions. Neither the LCPs mentioned herein nor their use as ovenware are mentioned.

### SUMMARY OF THE INVENTION

This invention relates to an ovenware part comprising:

(a) about 10 to about 200 parts per million of an alkali metal;

(b) a liquid crystalline polymer consisting essentially of repeat units of the formula:

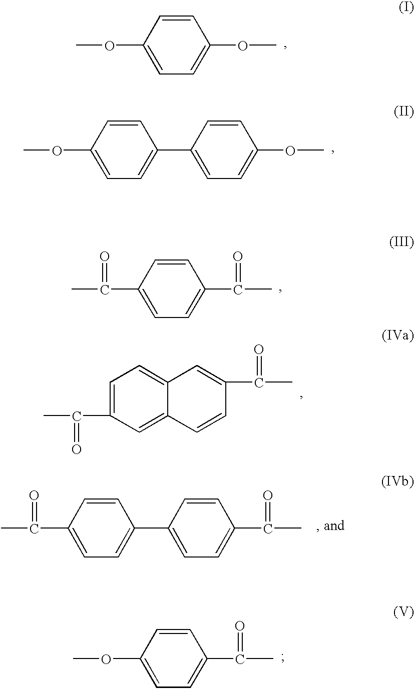

wherein

a molar ratio of (I):(II) is from 65:35 to 40:60;

a molar ratio of (III):(IVa plus IVb) is from 90:10 to 50:50;

a molar ratio of the total of (I) and (II) to the total of (III) and (IV) is substantially 1:1; and

there are 100 to 600 moles of (V) per 100 moles of (I) plus (II).

### DETAILED DESCRIPTION OF THE INVENTION

The present invention relates to molded parts, especially ovenware parts, comprised of certain LCPs containing an alkali metal, and how those parts are made. In these compositions, in comparison to the same compositions without the alkali metal, these parts have much less of a tendency to blister and/or warp when heated, especially when cycled from low to high temperature and back again to low temperature.

Alkali metals, as used herein, are selected from the group consisting of lithium, sodium, potassium, cesium, and rubidium. Preferred alkali metals are sodium, and potassium, and potassium is an especially preferred alkali metal.

The alkali metals are added to, and present in, the LCP preferably in the form of salt(s). The metal itself is present in the form of its cation.

Most of the LCPs described herein have been previously disclosed in U.S. Pat. Nos. 5,110,896 and 5,250,654, both of which are hereby included by reference. In the instant LCPs, repeat unit (I) is derived from hydroquinone, (II) is derived from 4,4′-biphenol, (III) is derived from terephthalic acid, (IVa) is derived from 2,6-naphthalene dicarboxylic acid, (IVb) is derived from 4,4′-bibenzoic acid, and (V) is derived from 4-hydroxybenzoic acid. Herein, when the number of moles of (IV) is given, it is the total number of moles of (IVa) and (IVb).

Any molar ratio of (IVa) to (IVb) may be used, but in preferred compositions, the ratio of moles of (IVb) to (IVa) [(IVb)/(IVa)] is 0 to about 2. In preferred compositions, the molar ratio of (I):(II) is from 65:35 to 40:60 and the molar ratio of (III):(IVa plus IVb) is from 90:10 to 50:50. In more preferred compositions, the molar ratio of (I):(II) is from 60:40 to 40:60 and the molar ratio of (III):(Iva plus IVb) is from 88:12 to 60:40. Preferably, the molar ratio of the total of (I) and (II) to the total of (III) and (IV) is substantially 1:1. When (IVb) is not present, it is preferred that there are 200 to 600 moles of (V) per 100 moles of (I) plus (II), more preferably about 200 to 450. When (IVb) is present, it is preferred that there are 100 to 600 moles of (V) per 100 moles of (I) plus (II), more preferably 100 to 400 moles of (V) per 100 moles of (I) plus (II), and even more preferably about 200 to 350 moles of (V) per 100 moles of (I) plus (II). In another preferred composition (IVb) is not present.

The LCPs may be made by any method known in the art, but it is preferred if they are made by converting all starting material hydroxyl groups to ester groups, particularly acetates, and then condensing the esters with the carboxyl groups in the starting materials to form the polymer. It is especially preferred if all the starting materials are combined, reacted with a carboxylic anhydride (especially acetic anhydride) to esterify the hydroxyl groups present, and then condensed to form the LCP.

The alkali metal (in the form of salts) may be added to the LCP by any method that results in a reasonably uniform mixture; that is, the metal cations (salt) should be well dispersed in the LCP. In one preferred method, the molten LCP may be mixed with the salt by using a mixer such as a twin screw extruder. If the salt is added to the already formed LCP, it is preferred if at least about 20%, preferably at least 50% or more, of the polymer end groups are carboxyl. The salt can also be added to the polymerization ingredients before or during the polymerization, especially before the polymerization is started. In an especially preferred method the alkali metal is added before or during the polymerization, and then it is preferred that the polymerization be done by condensing the ester of the hydroxyl groups in the monomers with the carboxyl groups in the monomers. In another method, the alkali metal (salts) may be present as “impurities” in one or more of the polymerization starting materials. In this case, the final LCP must still contain the minimum amount of alkali metal required.

In addition to the alkali metal (salts) present in the LCP, the compositions herein may also contain other materials, including but not limited to, fillers and reinforcing agents (such as talc, clay, glass fiber, mica, wollastonite, TiO₂, carbon fiber, and aramid fiber), colorants, antioxidants, etc. Especially preferred fillers are talc, TiO₂, and fibers, such as glass fiber, carbon fiber, and aramid fiber. Talc is more preferred. Preferably the ovenware or other part contains at least 20 percent by weight total of one or more of fillers, reinforcing agents, and pigments. It is preferred that these additional materials are melt mixed into the LCP, especially in a twin-screw extruder, and when melt mixed in a twin screw extruder it is preferred that these materials (some or all of them) are side fed directly into molten LCP in the extruder. By “side fed” or “side feeding” is meant the ingredient is introduced into the interior of the twin screw extruder downstream of the rear of the extruder where the liquid crystalline polymer (usually in solid form) is added to the extruder.

If a filler is added that contains an alkali metal, such as clay or a talc, such alkali metals (cations) are not included in the total of the metal ions in the polymer unless such metal ions leach from or react with the polymer. For instance, sodium may be present in glass fibers. If such sodium cannot leach from the fibers, it is not included in the metal cations used herein. However, if enough sodium leaches into the polymer to reach minimum level prescribed herein, it is included within the present invention.

As stated above, the alkali metal preferably is added to the LCP in the form of salts. The anion in the salt which is originally added to the LCP is not critical. Useful salts include, but are not limited to, bisulfates, sulfates, carbonates, bicarbonates, hydroxides, halides, and carboxylates. Preferred salts are bisulfates, sulfates, carbonates, bicarbonates and carboxylates. Preferred carboxylates are salts of aliphatic carboxylic acids containing 2 to 6 carbon atoms, and a carboxylate salt of any of the carboxylic acids from which the polymeric repeat units are derived. Especially preferred carboxylates are acetate and 4-hydroxybenzoate.

In preferred compositions, about 10 parts per million (ppm) by weight to about 200 ppm by weight of the alkali metal, more preferably about 10 ppm by weight to about 50 ppm of the alkali metal, based on the weight of the LCP, is present in the LCP composition. The amount of metal present in the composition can be measured by a variety of analytical techniques. Analyses may be done by Inductively Coupled Plasma Atomic Absorption, as described in U.S. Pat. No. 5,397,502.

By ovenware are meant items that may be placed in a thermal and/or microwave oven to cook and/or heat foods at temperatures normally used for such purposes. These are usually in the form of containers such as cups, pots and bowls of various shapes and sizes, or relatively flat items such as those shaped similar to dishes. These items may or may not have covers which may or may not be made of the compositions described herein.

In the Examples, the polymer used had the composition (repeat units) 4,4′-biphenol/hydroquinone/terephthalic acid/2,6-napthalenedicaboxylic acid/4-hydroxybenzoic acid in a 50/50/87.5/12.5/300 molar ratio. This polymer may be synthesized by methods described in U.S. Pat. No. 5,525,700. The method described in the Examples of this U.S. Patent was actually used to make the polymers of the Examples herein. For Examples 1-3, 15 ppm potassium (as potassium), based on the final polymer after polymerization was complete, was added to the initial polymerization mixture as the potassium salt of 4-hydroxybenzoic acid, while for Comparative Examples no potassium was added to the polymerization.

In the Examples, the following materials were used:

Jetfil® 575C talc, available from Luzenac America, Inc., Englewood, Colo., U.S.A.

Tiona® RCL4 Titanium Dioxide, a chloride process rutile-type TiO₂ surface treated with alumina and an organic substance, available from SMC Corp. of Baltimore, Md., U.S.A..

Ultranox® 626, a phosphorous containing antioxidant, available from GE Specialty Chemicals.

### EXAMPLES 1-3 AND COMPARATIVE EXAMPLES A AND B

Compounding of LCP resins with the talc, TiO₂, Ultranox® 626 phosphite stabilizer was done in a 40 mm ZSK Werner and Pfleiderer twin-screw extruder having a zone with conventional conveying elements, a zone with kneading or mixing elements, and a low pressure zone with venting under vacuum of any volatiles from the polymer melt, and a die. As the compounded compositions exited the die, they were quenched with a water spray and cut into pellets with a conventional strand cutter. The extruder barrel and die temperatures were maintained at about 340° C. Prior to molding the pellets, the pellets were dried overnight for approximately 16 hours in a vacuum oven with N₂ purge at 150° C. The LCP compositions of Example 1 and 2 and Comparative Example A contained (all weight percents) 54.7% LCP, 41.0% Jetfil® 575C talc, 5.0% Tiona® RCL4 TiO₂, and 0.30% Ultranox® 626. In Example 1 and Comparative Example A the talc was side fed to the extruder, while in Example 2 it was rear fed. In Example 3 and Comparative Example B the composition used was 54.7% LCP, 41.1% Jetfil® 575C talc, 3.9% green pigment, and 0.3% Ultranox® 626, and the talc was side fed.

Discs, 10.2 cm in diameter and 0.16 cm thick, were molded on a 6 oz. (171 g) single screw injection molding machine, using a barrel temperature of 345° C., a nozzle temperature of 345-350° C., a mold temperature of 115° C., a screw speed of 120 rpm, a 1,5 sec. injection boost, 5 sec injection, 10 or 15 sec. hold time, and mold open time of about 3 sec. Injection boost pressure was 35 MPa, injection pressure was 28 MPa, and back pressure was 350 kPa.

The discs were heat aged for 20 min at 250° C., cooled to ambient temperature, and then visually inspected for blistering and warpage. No blistering or warpage is indicated in Table 1 with “−”, some blistering or warpage with “+”, and much warpage with “++”. The color of the disc before and after heat aging was also measured according to ASTM-2244-93 to measure the “Delta E” and “Delta L” values. (“Delta” is denoted in the tables as δ). For commercial purposes, heat-treated articles usually should have a low Delta E and Delta L.

Details of the Examples are given in Table 1.

TABLE 1

| Ex. | δL | δE | Hold Time, sec | Blistering | Warpage |
|---|---|---|---|---|---|
| A | 85.15 | 1.775 | 10 | − | + |
| | | | 15 | + | + |
| 1 | 83.79 | 0.895 | 10 | − | − |
| | | | 15 | − | − |
| 2 | 84.03 | 1.123 | 10 | − | ++ |
| | | | 15 | − | + |
| B | 70.82 | 0.849 | 10 | + | + |
| | | | 15 | − | − |
| 3 | 70.49 | 0.765 | 10 | − | − |
| | | | 15 | − | − |

The results of Table 1 show that the presence of potassium and/or longer mold hold times reduce blistering, while the use of side feeding and/or longer mold hold times reduces warping, and any combination of these features in making ovenware is preferred.

What is claimed is:

1. An ovenware part comprising:
(a) about 10 to about 200 parts per million of an alkali metal;
(b) a liquid crystalline polymer consisting essentially of repeat units of the formula: 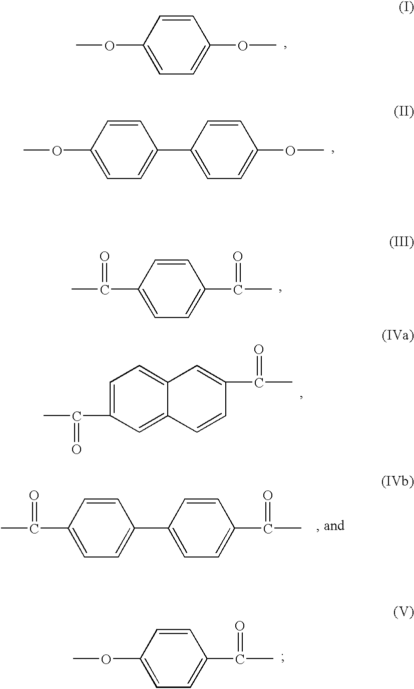
wherein
a molar ratio of (I):(II) is from 65:35 to 40:60;
a molar ratio of (III):(IVa plus IVb) is from 90:10 to 50:50;
a molar ratio of the total of (I) and (II) to the total of (III) and (IV) is substantially 1:1; and
there are 100 to 600 moles of (V) per 100 moles of (I) plus (II).

2. The ovenware part as recited in claim 1 which further comprises at least 20 percent by weight total of one or more fillers, reinforcing agents and pigments.

3. The ovenware part as recited in claim 2 wherein said fillers, reinforcing agents and pigments are melt mixed in a twin screw extruder into said liquid crystalline polymer, when said liquid crystalline polymer is molten, by side feeding.
